(19) United States
(12) Patent Application Publication
(10) Pub. No.: US 2020/0292066 A1
(43) Pub. Date: Sep. 17, 2020

(54) TORQUE CONVERTER CONTROLLER AND TORQUE CONVERTER

(71) Applicant: AISIN SEIKI KABUSHIKI KAISHA, Kariya-shi (JP)

(72) Inventor: Yukihisa TSUZUKI, Kariya-shi (JP)

(73) Assignee: AISIN SEIKI KABUSHIKI KAISHA, Kariya-shi (JP)

(21) Appl. No.: 16/815,110

(22) Filed: Mar. 11, 2020

(30) Foreign Application Priority Data
Mar. 11, 2019 (JP) 2019-043779

(51) Int. Cl. F16H 61/00; F16H 41/24; F16H 61/14

(52) U.S. Cl. CPC F16H 61/0021; F16H 45/02; F16H 61/14; F16H 41/24

(57) ABSTRACT

A torque converter controller includes a pressure regulator connected to a pipe that delivers a fluid circulating through a pump impeller and a turbine runner of a torque converter, the pressure regulator changing a pressure applied to the fluid based on a plurality of states of a vehicle where the torque converter controller is mounted, the plurality of states including a starting state where the vehicle is starting and at least one of a stopped state where the vehicle is stopped and a cruising state where the vehicle is cruising.

### CROSS REFERENCE TO RELATED APPLICATIONS

This application is based on and claims priority under 35 U.S.C. § 119 to Japanese Patent Application 2019-043779, filed on Mar. 11, 2019, the entire content of which is incorporated herein by reference.

### TECHNICAL FIELD

This disclosure generally relates to a torque converter controller controlling a torque converter and the torque converter at which the torque converter controller is mounted.

### BACKGROUND DISCUSSION

Known torque converters are disclosed in JP2009-209979A (hereinafter referred to as Reference 1) and JP2016-095015A (hereinafter referred to as Reference 2), for example. The torque converter disclosed in Reference 1 includes stator blades each of which is divided into two so that the shape of each stator blade of a stator is changed by a biasing force of a spring and a pressing force of hydraulic oil, for example, depending on a driving state of a vehicle. That is, performance of the torque converter is varied depending on the driving state of the vehicle. The torque converter improves its performance in an idling state without deteriorating a power performance in a driving state.

The torque converter disclosed in Reference 2 changes the internal pressure of the torque converter depending on whether a lock-up state is established so as to improve responsiveness when the lock-up state is established.

According to the torque converter disclosed in Reference 1, the number of components constituting the stator increases, which may lead to increase of a process for assembling such components. A manufacturing cost, size, and weight of the stator may thus increase. A mounting performance and a power performance of the torque converter incorporating the stator may decrease.

According to the torque converter disclosed in Reference 2, responsiveness at the time the lock-up state is established improves. Nevertheless, a fuel consumption and a power performance in the idling state may not improve.

A need thus exists for a torque converter controller and a torque converter which are not susceptible to the drawback mentioned above.

### SUMMARY

According to an aspect of this disclosure, a torque converter controller includes a pressure regulator connected to a pipe that delivers a fluid circulating through a pump impeller and a turbine runner of a torque converter, the pressure regulator changing a pressure applied to the fluid based on plural states of a vehicle where the torque converter controller is mounted, the plural states including a starting state where the vehicle is starting and at least one of a stopped state where the vehicle is stopped and a cruising state where the vehicle is cruising.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view partially illustrating a torque converter where a torque converter controller is mounted according to an embodiment disclosed here;

FIG. 2 is a diagram showing a capacity coefficient that is changed depending on each of plural states of a vehicle according to the torque converter controller illustrated in FIG. 1;

FIG. 3 is a flow chart of a processing performed by a controller for changing the capacity coefficient depending on each state of the vehicle according to the torque converter controller illustrated in FIG. 1;

FIG. 4 is a schematic view partially illustrating a torque converter where a torque converter controller is mounted according to a third modified example disclosed here; and

FIG. 5 is a diagram showing an operation of a temperature-sensitive bimetallic orifice according to the torque converter controller illustrated in FIG. 4.

### DETAILED DESCRIPTION

An embodiment and modified examples thereof are explained with reference to the attached drawings. The same reference numerals are assigned to components that are common among the drawings. A component (components) illustrated in one drawing may not appear in the other drawings for reasons of convenience. Additionally, the drawings may not be illustrated in the correct scale.

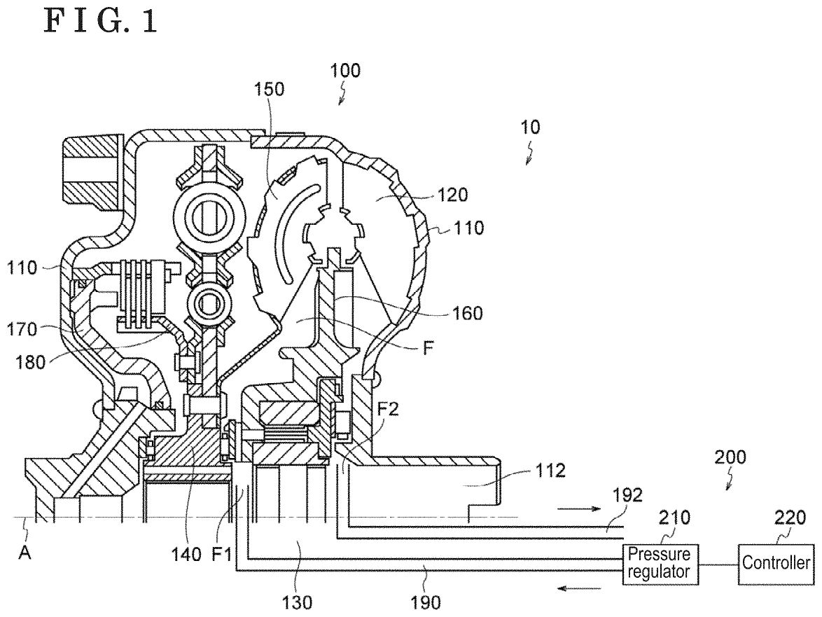

As illustrated in FIG. 1, a torque converter 10 according to a present embodiment includes a torque converter body 100 and a torque converter controller 200 mounted at the torque converter body 100. In FIG. 1, a part of the torque converter body 100 is illustrated in a cross-sectional view and the torque converter controller 200 is illustrated in a functional block diagram.

Various kinds of known torque converters may be employed for the torque converter body 100. The construction of the torque converter body 100 is thus simply explained as below.

The torque converter body 100 includes a case 110 in a box form, a pump impeller 120, an output shaft 130, a support portion 140, a turbine runner 150, and a stator wheel 160. The case 110 is mounted to be rotatable around a center axis A of the torque converter body 100 while extending substantially annularly. The pump impeller 120 is mounted inside the case 110 while extending substantially annularly. The output shaft 130 extends from the inside of the case 110 to the outside thereof along the center axis A in a rotatable manner relative to the case 110. The support portion 140 is fixed to the output shaft 130 while extending substantially annularly. The turbine runner 150 is fixed to the support portion 140 while extending substantially annularly in a state there the turbine runner 150 is opposed to the pump impeller 120. The stator wheel 160 is provided to be rotatable relative to the output shaft 130 while extending substantially annularly between the pump impeller 120 and the turbine runner 150.

The torque converter body 100 includes a first engagement portion 170 and a second engagement portion 180 that is engageable with the first engagement portion 170. The first engagement portion 170 is fixed to the inside of the case 110 while extending substantially annularly. The second engagement portion 180 is fixed to the support portion 140 at the inside of the case 110 while extending substantially annularly.

The torque converter body 100 includes a first pipe 190 and a second pipe 192. The first pipe 190 is provided inside the output shaft 130 and is connected to an entrance F1 of a flow passage F of hydraulic oil (fluid), the flow passage F being formed at the inside of the case 110. The second pipe 192 is provided inside the output shaft 130 and is connected to an exit F2 of the flow passage F of the hydraulic oil.

The case 110 is fixed to an output shaft of an engine (EG) that is arranged at one side of the case 110 (i.e., a left side in FIG. 1) so that the case 110 rotates integrally with the output shaft of the engine. The case 110 includes an opening portion 112 through which the output shaft 130 extending inside the case 110 is led to a transmission (TM) arranged at the other side of the case 110 (i.e., a right side in FIG. 1).

The pump impeller 120 is fixed to the case 110 and is thus integrally rotatable with the case 110, i.e., integrally rotatable with the output shaft of the engine. The pump impeller 120 includes a pump impeller blade that is rotatable around the center axis A.

The turbine runner 150 is fixed to the support portion 140 and is thus integrally rotatable with the output shaft 130 to which the support portion 140 is fixed. The turbine runner 150 includes a turbine runner blade that is rotatable around the center axis A.

The case 110 includes therein the flow passage F through which the hydraulic oil flows and which is connected to the pump impeller 120, the turbine runner 150, and the stator wheel 160, for example.

In a case where the pump impeller blade of the pump impeller 120 integrally rotates with the output shaft of the engine, the hydraulic oil flows from the pump impeller blade to a turbine runner blade of the turbine runner 150. This causes the turbine runner blade to also rotate. The hydraulic oil that has flowed to the turbine runner blade returns to the pump impeller 120 through the stator wheel 160. Such returned hydraulic oil accelerates the rotation of the pump impeller blade of the pump impeller 120. This causes torque transmitted from the pump impeller 120 (the output shaft of the engine) to the turbine runner 150 (the output shaft 130) to be amplified.

The hydraulic oil flowing through the pump impeller 120, the stator wheel 160, and the turbine runner 150 is stirred thereby so as to be heated, due to fluid shear force, to a high temperature such as over 100° C., for example. In order to cool such heated hydraulic oil, the hydraulic oil passing through the flow passage F is sent to the second pipe 192 from the exit F2. Then, after passing through a pressure regulator 210 of the torque converter controller 200, the hydraulic oil is sent to the first pipe 190 to return to the flow passage F inside the case 110 from the entrance F1.

The first engagement portion 170 fixed to the case 110, i.e., fixed to the output shaft of the engine, and the second engagement portion 180 fixed to the support portion 140, i.e., fixed to the output shaft 130, together establish a lock up mechanism. Specifically, the first engagement portion 170 and the second engagement portion 180 engage with each other to achieve a lock-up state so that the case 110 (the output shaft of the engine) and the support portion 140 (the output shaft 130) are integrally rotatable. The first engagement portion 170 and the second engagement portion 180 disengage from each other to release the lock-up state so that the case 110 (the output shaft of the engine) and the support portion 140 (the output shaft 130) are rotatable relative to each other.

As illustrated in FIG. 1, the torque converter controller 200 that is connected to the first pipe 190 and the second pipe 192 delivering the hydraulic oil mainly includes the pressure regulator 210 and a controller 220. The pressure regulator 210 changes a pressure applied to the hydraulic oil depending on each of plural states of the vehicle where the torque converter 10 is mounted. The controller 220 detects each state of the vehicle and controls the pressure regulator 210 based on the detected state of the vehicle.

The pressure regulator 210 may be a pressure regulating valve (i.e., a hydraulic control valve) that applies a pressure to the hydraulic oil delivered by the first pipe 190 and the second pipe 192 in response to each of the plural states of the vehicle. Specifically, the pressure regulating valve may include a valve member that is movable between a closed position for closing a flow passage through which the hydraulic oil flows from the second pipe 192 to the first pipe 190, and an open position for opening the flow passage, a spring biasing the valve member to the closed position, and a solenoid pressing the valve member to the open position in response to a value of a voltage input to the solenoid. The valve member may change an amount of hydraulic oil flowing to the first pipe 190 from the second pipe 192 per time unit, i.e., the pressure applied to the hydraulic oil, in accordance with a magnitude of a voltage applied to the solenoid by the controller 220. The pressure regulator 210 changes the amount of hydraulic oil flowing to the first pipe 190 from the second pipe 192 per time unit by changing the position of the valve member using the solenoid, in response to a signal (such as a voltage, for example) received from the controller 220. The pressure regulator 210 thus changes the pressure (i.e., charge pressure) applied to the hydraulic oil delivered by the first pipe 190 and the second pipe 192 accordingly.

The pressure regulator 210 is not limited to have the aforementioned construction. For example, the pressure regulator 210 may be any hydraulic control valve that is able to change the aforementioned pressure in plural steps, for example.

The controller 220 is able to deal with three states, for example, serving as the plural states of the vehicle according to the embodiment. The three states of the vehicle include a stopped state where the vehicle is stopped (i.e., the vehicle is idling), a starting state where the vehicle is starting, and a cruising state where the vehicle is cruising. The controller 220 detects the three states of the vehicle and changes the signal (the voltage, for example) supplied to the pressure regulator 210 in response to the detected state of the vehicle.

In order to achieve the above, the controller 220 may be constituted by a microcomputer, for example, mainly including a central processing unit (CPU), a storage unit including a read only memory (ROM) and a random access memory (RAM), and an input/output interface. The CPU controls the signal (voltage) supplied to the pressure regulator 210 by executing program (specifically, plural commands including in program) that is stored at the ROM while using a tentative storage function of the RAM.

The controller 220 obtains information related to the number of rotations of the output shaft of the transmission in a state being connected to a sensor that is provided to detect the number of rotations of the output shaft of the transmission. The controller 220 is thus able to calculate a moving speed of the vehicle based on the number of rotations (i.e., a rotation speed) of the output shaft of the transmission per time unit. The controller 220 may obtain information related to the moving speed of the vehicle calculated on a basis of the rotation speed of the output shaft of the transmission per time unit using the aforementioned sensor or a component provided for the sensor.

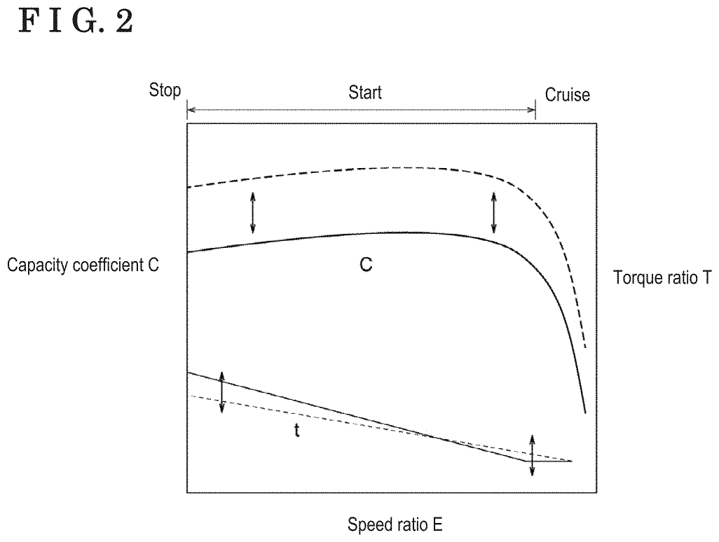

In another example of the embodiment, the controller 220 may detect the state of the vehicle based on a ratio between the number of rotations (rotation speed) of the output shaft of the engine and the number of rotations (rotation speed) of an input shaft of the transmission. Specifically, the controller 220 detects a speed ratio E′ serving as the ratio between the number of rotations (rotation speed) of the output shaft of the engine and the number of rotations (rotation speed) of the input shaft of the transmission. The speed ratio E′ is similar to a ratio between the number of rotations (rotation speed) of the output shaft of the engine and the number of rotations (rotation speed) of the output shaft of the transmission, i.e., a speed ratio E, which is explained later with reference to FIG. 2. The state of the vehicle is thus detectable from the speed ratio E. In this case, information generated closer to an operation side (i.e., a front side) of the vehicle is usable as compared to the case where the number of rotations (rotation speed) of the output shaft of the transmission per time unit is utilized. The moving speed of the vehicle is promptly detectable accordingly.

The controller 220 is further able to obtain information indicating a position of a throttle (throttle opening) output from a sensor (specifically, a throttle position sensor) provided for an acceleration pedal of the vehicle.

The controller 220 detects whether the vehicle is in the starting state (or in a deceleration state), the stopped state, or the cruising state based on the information indicating the moving speed of the vehicle and the information indicating the throttle opening obtained in the aforementioned manner.

Characteristics of the engine are basically different between a steady state (cruising state) and a starting state of the vehicle. Characteristics of the torque converter are also different between the steady state (with a high speed ratio) and the starting state (with a low speed ratio) of the vehicle. The characteristics of the engine and the torque converter in the steady state may not be in an ideal combination. The characteristics of the engine and the torque converter in the starting state may not be in an ideal combination.

Specifically, in the starting state of the vehicle, an engine torque should be low and the characteristics (a capacity coefficient) of the torque converter should be low. The engine torque should be high and the characteristics of the torque converter should be high in the steady state (cruising state) of the vehicle. The characteristics of the torque converter should be low in the stopped state of the vehicle (i.e., the vehicle is idling) to reduce an engine load.

According to the present embodiment, the capacity coefficient (i.e., performance) of the torque converter is changeable depending on each state of the vehicle to achieve the ideal combination between the characteristics of the engine and the characteristics of the torque converter.

In a case where the construction of the torque converter body 100 is not substantially changed, a mounting performance and a power performance of the torque converter body 100 are restrained from decreasing and a manufacturing cost thereof is restrained from increasing. Thus, in order to vary the capacity coefficient of the torque converter, the pressure (oil pressure) applied to the hydraulic oil circulating through the flow passage F of the torque converter body 100 is varied to change an apparent density of the hydraulic oil.

Specifically, a capacitance coefficient C of the torque converter is basically representable by the following formula. Capacitance coefficient C={[(density of hydraulic oil)/(gravitational acceleration)]×(circulation flow speed)×(flow passage area)×[(pump exit diameter)×(angular speed)−(circulation flow speed)×(pump exit blade angle)]×(pump exit diameter)+(circulation flow speed)×(stator exit blade angle)×(stator exit diameter)}/(number of rotations)²

The hydraulic oil circulating inside the torque converter body 100 generates bubbles in a state where the oil is stirred by the pump impeller 120, the turbine runner 150, and the stator wheel 160. The density of such hydraulic oil including the bubbles that contain air inside is smaller than the density of hydraulic oil not including bubbles.

Increasing the pressure applied to the hydraulic oil thus eliminates bubbles included in the hydraulic oil to thereby increase the apparent density of the hydraulic oil. The capacity coefficient C increases accordingly. On the contrary, decreasing the pressure applied to the hydraulic oil allows bubbles in the hydraulic oil to thereby decease the apparent density of the hydraulic oil. The capacity coefficient C decreases accordingly.

In the embodiment, the controller 220 varies the capacity coefficient C depending on each state of the vehicle as illustrated in FIG. 2.

In FIG. 2, a horizontal axis indicates the speed ratio E of the torque converter body 100 ([rotation speed (the number of rotations) of the output shaft 130]/[rotation speed (the number of rotations) of EG output shaft]) and a vertical axis indicates the capacitance coefficient C (left side) and a torque ratio T (right side) ([torque of the output shaft 130]/[torque of the case 110]) of the torque converter body 100.

In FIG. 2, characteristics (i.e., the capacity coefficient C and the torque ratio T) obtained in the stopped state, the starting state, and the cruising state when the pressure applied to the hydraulic oil is specified to be small (i.e., to a first value) are indicated with a solid line. Additionally, characteristics (the capacity coefficient C and the torque ratio T) obtained in the stopped state, the starting state, and the cruising state when the pressure applied to the hydraulic oil is specified to be large (i.e., to a second value greater than the first value) is indicated with a dashed line in FIG. 2.

The controller 220 specifies the pressure applied to the hydraulic oil as small as possible (i.e., specifies the pressure to be an initial value) in a case where the detected state of the vehicle is the stopped state so as to utilize the capacity coefficient C that is specified to be minimized. In a case where the detected state of the vehicle is the starting state, the controller 220 specifies the pressure applied to the hydraulic oil to be small (i.e., specifies the pressure to be the first value greater than the initial value) so as to utilize the capacity coefficient C indicated with the solid line in FIG. 2. In a case where the detected state of the vehicle is the cruising state, the controller 220 specifies the pressure applied to the hydraulic oil to be large (i.e., specifies the pressure to be the second value greater than the first value) so as to utilize the capacity coefficient C indicated with the dashed line in FIG. 2. The controller 220 selectively employs the capacity coefficient C indicated with the solid line or the capacity coefficient C indicated with the dashed line in FIG. 2 depending on the detected state of the vehicle.

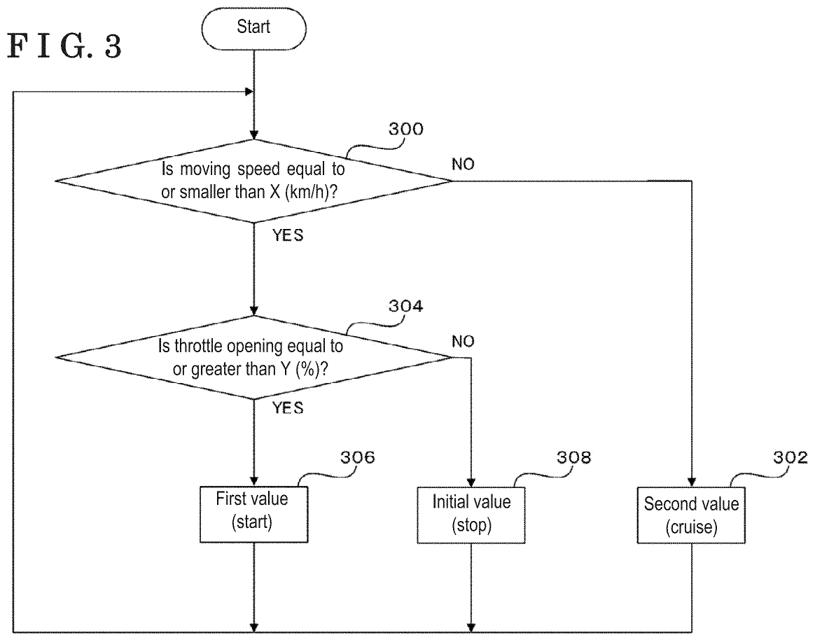

The processing performed by the controller 220 of the torque converter controller 200 illustrated in FIG. 1 for changing the capacity coefficient C depending on each state of the vehicle is explained with reference to a flow chart in FIG. 3.

The controller 220 determines whether the moving speed of the vehicle is equal to or smaller than a predetermined speed X, such as 30 km/h, for example, at step (hereinafter referred to as “ST”) 300. When the moving speed of the vehicle is determined to be greater than the predetermined speed X, the controller 220 determines that the vehicle is in the cruising state at ST 302. The controller 220 selects the second value (that is greater than the initial value and the first value) for the pressure applied to the hydraulic oil and provides the pressure regulator 210 with a signal (such as a voltage, for example) corresponding to the second value. The pressure regulator 210 thus specifies the pressure applied to the hydraulic oil to the second value to utilize the capacity coefficient C (for the cruising state) as indicated with the dashed line in FIG. 2. When the controller 220 determines that the moving speed of the vehicle is equal to or smaller than the predetermined speed X at ST 300, the controller 220 proceeds the operation to ST 304.

The controller 220 determines whether the throttle opening (%) is equal to or greater than a predetermined value Y at ST 304. When determining that the throttle opening is equal to or greater than the predetermined value Y, the controller 220 determines that the vehicle is in the starting state at ST 306. The controller 220 selects the first value (that is greater than the initial value and is smaller than the second value) for the pressure applied to the hydraulic oil and provides the pressure regulator 210 with the signal (voltage) corresponding to the first value. The pressure regulator 210 thus specifies the pressure applied to the hydraulic oil to the first value to utilize the capacity coefficient C (for the starting state) as indicated with the solid line in FIG. 2.

On the other hand, when determining that the throttle opening is smaller than the predetermined value Y, the controller 220 determines that the vehicle is in the stopped state at ST 308. The controller 220 selects the initial value (that is smaller than the first value and the second value) for the pressure applied to the hydraulic oil and provides the pressure regulator 210 with the signal (voltage) corresponding to the initial value. The pressure regulator 210 thus specifies the pressure applied to the hydraulic oil to the initial value to utilize the capacity coefficient C (for the stopped state) that is smaller than the capacity coefficient C indicated with the solid line or the dashed line in FIG. 2.

According to the present embodiment, the pressure applied to the hydraulic oil decreases to the initial value in the stopped state (idling state) of the vehicle to decrease the performance (capacity coefficient) of the torque converter body 100. This allows the engine load to decrease so that a fuel consumption may improve in the idling state of the vehicle. Additionally, the pressure applied to the hydraulic oil is made small to the first value in the starting state (and in the deceleration state) so that the performance (capacity coefficient) of the torque converter body 100 is restrained. This causes the number of rotations (rotation speed) of the engine to increase and a large torque to be transmitted to the transmission. The power performance (acceleration performance) of the torque converter may improve accordingly. Further, the pressure applied to the hydraulic oil increases to the second value in the cruising state so that the performance (capacity coefficient) of the torque converter body 100 increases. This causes the number of rotations (rotation speed) of the engine to be small and a large torque to be transmitted to the transmission. The power performance (acceleration performance), fuel consumption, and quietness may improve.

Next, modified examples are explained as below. In FIG. 2, the controller 220 detects the three states of the vehicle including the stopped state, the starting state (deceleration state), and the cruising state serving as the plural states of the vehicle, and outputs the signal depending on each state of the vehicle. According to a first modified example, the controller 220 may further divide the starting state (the deceleration state) into two states, i.e., a first starting state (a first deceleration state) and a second starting state (a second deceleration state) that occurs after the first starting state (the first deceleration state).

In the aforementioned state, the controller 220 may identify and detect the first starting state and the second starting state based on the magnitude of the throttle opening, for example. Additionally, the controller 220 may identify and detect the first deceleration state and the second deceleration state based on a depression amount of a brake pedal that is detectable from a sensor provided for the brake pedal, for example.

The controller 220 selects a value I (that is greater than the initial value and smaller than the second value) for the first starting state to provide a signal (a voltage, for example) corresponding to the value Ito the pressure regulator 210. In the same manner, the controller 220 selects a value II (that is greater than the initial value and the value I and smaller than the second value) for the second starting state to provide a signal (a voltage, for example) corresponding to the value II to the pressure regulator 210.

Additionally, the controller 220 selects a value III (that is smaller than the second value and greater than the initial value) for the first deceleration state to provide a signal (a voltage, for example) corresponding to the value III to the pressure regulator 210. In the same manner, the controller 220 selects a value IV (that is smaller than the value III and greater than the initial value) for the second deceleration state to provide a signal (a voltage, for example) corresponding to the value IV to the pressure regulator 210.

The controller 220 may detect only the stopped state and the starting state (deceleration state) or detect only the starting state (deceleration state) and the cruising state, instead of detecting the three states constituted by the stopped state, the starting state, and the cruising state. In any cases, the controller 220 may detect each state in the same manner as illustrated in FIG. 3.

In FIG. 3, the controller 220 detects a transition (shifting) from the starting state to the cruising state based on the magnitude of the moving speed of the vehicle. According to a second modified example, the controller 220 may detect the transition from the starting state to the cruising state based on the number of rotations (rotation speed) of the engine and the engine torque, for example.

In a first example, the controller 220 stores, as a threshold value, the number of rotations (rotation speed) of the engine corresponding to the maximum torque of the engine in the starting state at the ROM, for example, for a specific vehicle (one or more than one vehicles). The controller 220 monitors the rotation speed of the engine after the vehicle is shifted from the stopped state to the starting state (such shifting is detectable in accordance with the flow chart in FIG. 3). When the rotation speed of the engine exceeds the threshold value, the controller 220 determines that the vehicle is shifted from the starting state to the cruising state. The aforementioned rotation speed of the engine and the engine torque are obtainable from a known technique, such as from an engine control unit (ECU), for example.

In a second example, the controller 220 monitors the rotation speed of the engine and the engine torque corresponding thereto in the starting state on a real-time basis for obtaining and storing (updating) the rotation speed of the engine corresponding to the maximum engine torque as the threshold value. The controller 220 then monitors the rotation speed of the engine after the vehicle is shifted from the stopped state to the starting state in the same manner as the first example, and determines that the vehicle is shifted from the starting state to the cruising state when the rotation speed of the engine exceeds the aforementioned threshold value.

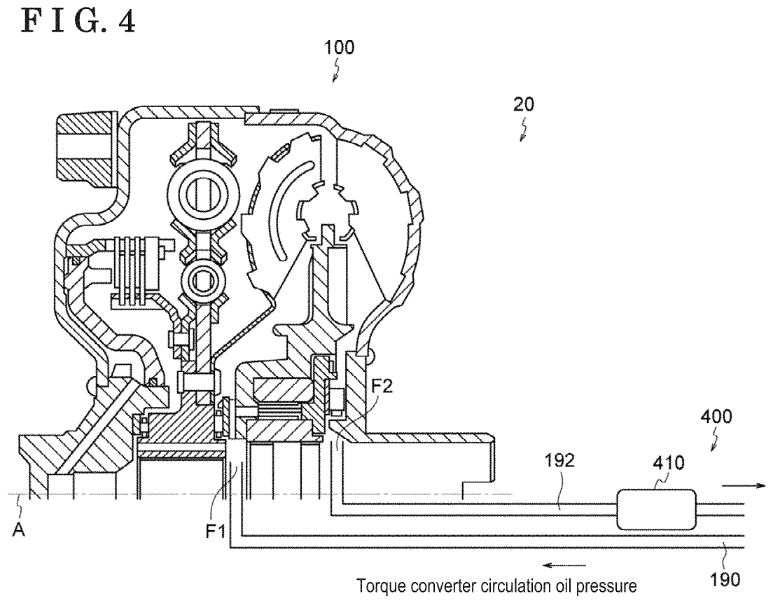

A third modified example is explained with reference to FIG. 4.

A torque converter 20 illustrated in FIG. 4 includes the torque converter body 100 and a torque converter controller 400. The torque converter body 100 is the same as that in the embodiment illustrated in FIG. 1 and thus an explanation thereof is omitted.

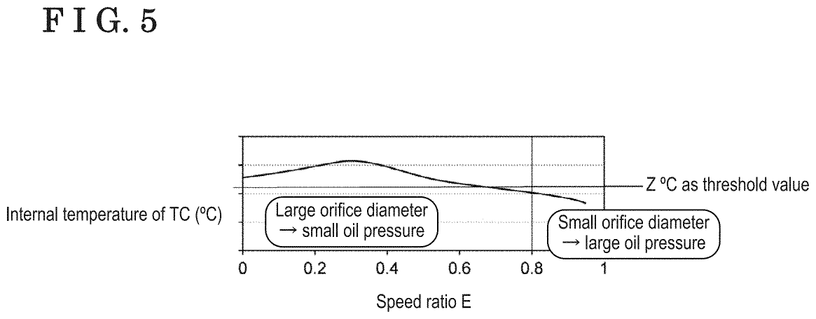

The torque converter controller 400 according to the third modified example differs from the torque converter controller 200 illustrated in FIG. 1 in including a temperature-sensitive bimetallic orifice 410 and not including the pressure regulator 210 and the controller 220. The temperature-sensitive bimetallic orifice (hereinafter simply referred to as the orifice) 410 is disposed and connected between the second pipe 192 and the first pipe 190, for example. The orifice 410 supplies the hydraulic oil delivered from the second pipe 192 to the first pipe 190 while changing or maintaining the pressure of such hydraulic oil to a predetermined value. Specifically, the orifice 410 has a first diameter in a case where the temperature of the hydraulic oil passing through the orifice 410 is greater than a predetermined temperature (i.e., a temperature Z° C. in FIG. 5). The orifice 410 has a second diameter in a case where the temperature of the hydraulic oil passing through the orifice 410 is equal to or smaller than the aforementioned predetermined temperature (Z° C.).

The hydraulic oil has a higher temperature than the predetermined temperature in the starting state of the vehicle because the hydraulic oil is stirred at the pump impeller 120, the stator wheel 160, and the turbine runner 150 (i.e., by fluid shear force) while circulating through the flow passage F of the torque converter body 100. The hydraulic oil including such higher temperature causes the diameter of the orifice 410 to be changed or maintained to the first diameter by flowing through the orifice 410. The orifice 410 thus specifies the pressure applied to the hydraulic oil to a value conforming to the first diameter (i.e., the value smaller than a value conforming to the second diameter of the orifice 410). The pressure applied to the hydraulic oil thus decreases, which leads to a reduced apparent density of the hydraulic oil. The capacity coefficient C of the torque converter body 100 decreases accordingly.

In the cruising state, the torque converter body 100 causes the pump impeller 120 and the turbine runner 150 to substantially integrally rotate with each other because of a large speed ratio E. The hydraulic oil circulating through the flow passage F is less stirred (i.e., a small amount of hydraulic oil is stirred) or substantially not stirred. The hydraulic oil thus has a temperature equal to or smaller than the predetermined temperature. The hydraulic oil including such temperature causes the diameter of the orifice 410 to be changed or maintained to the second diameter smaller than the first diameter by flowing through the orifice 410. The orifice 410 thus specifies the pressure applied to the hydraulic oil to the value conforming to the second diameter (i.e., the value greater than the value conforming to the first diameter of the orifice 410). The pressure applied to the hydraulic oil thus increases, which leads to an increased apparent density of the hydraulic oil. The capacity coefficient C of the torque converter body 100 increases accordingly.

The orifice 410 autonomously detects each of the starting state and the cruising state without the controller 220 that is provided in FIG. 1. The orifice 410 changes the pressure applied to the hydraulic oil depending on each state of the vehicle, so that the capacity coefficient of the torque converter body 100 is changeable or variable.

The orifice 410 illustrated in FIG. 4, and the pressure regulator 210 and the controller 220 illustrated in FIG. 1 may be combined and utilized at the same time. In this case, shifting between the stopped state and the starting state may be performed by the pressure regulator 210 and the controller 220 and shifting between the starting state and the cruising state may be performed by the orifice 410.

The aforementioned embodiments may be mutually combined unless inconsistency is generated.

According to the aforementioned embodiment, a torque converter controller 200 includes a pressure regulator 210 connected to a pipe 190, 192 that delivers hydraulic oil (fluid) circulating through a pump impeller 120 and a turbine runner 150 of a torque converter 10, the pressure regulator changing a pressure applied to the hydraulic oil based on plural states of a vehicle where the torque converter controller 200 is mounted, the plural states including a starting state where the vehicle is starting and at least one of a stopped state where the vehicle is stopped and a cruising state where the vehicle is cruising.

The torque converter controller 200 further includes a controller 220 detecting each of the plural states of the vehicle and controlling the pressure regulator 210 based on the detected state of the vehicle.

In addition, the controller 220 controls the pressure regulator 210 in the starting state so that the pressure applied to the hydraulic oil is greater than the pressure applied to the hydraulic oil in the stopped state in a case where the plural states of the vehicle includes at least the starting state and the stopped state. The controller 220 controls the pressure regulator 210 in the cruising state so that the pressure applied to the hydraulic oil is greater than the pressure applied to the hydraulic oil in the starting state in a case where the plural states of the vehicle includes at least the starting state and the cruising state.

According to the first modified example, the starting state includes a first starting state and a second starting state that occurs after the first starting state. The controller 220 controls the pressure regulator 210 so that the pressure applied to the hydraulic oil in the second starting state is greater than the pressure applied to the hydraulic oil in the first starting state.

According to the second modified example, the controller 220 acquires, as a threshold value, the number of rotations of an engine of the vehicle corresponding to a maximum torque of the engine obtained in the starting state of the vehicle. The controller 220 detects the cruising state when the number of rotations of the engine exceeds the threshold value.

According to the embodiment, the pressure regulator 220 is a pressure regulating valve connected to the pipe 190, 192 and applying a pressure conforming to each of the plural states of the vehicle to the hydraulic oil that is delivered from the pipe 190, 192.

According to the third modified example, the plural states of the vehicle include the cruising state and the starting state. The pressure regulator is a temperature-sensitive bimetallic orifice 410 connected to the pipe 190, 192 and including a first diameter in the starting state and a second diameter that is smaller than the first diameter in the cruising state so that a pressure applied to the hydraulic oil is greater than a pressure applied to the hydraulic oil in the starting state.

The orifice 410 has the first diameter in a case where the temperature of the hydraulic oil is greater than a predetermined temperature and has the second diameter in a case where the temperature of the hydraulic oil is equal to or smaller than the predetermined temperature.

According to the embodiment, the pressure regulator 210 increases and decreases the apparent density of the hydraulic oil by increasing and decreasing the pressure applied to the hydraulic oil.

According to the embodiment, the torque converter 10 includes the pressure regulator 210 connected to the pipe 190, 192 that delivers the hydraulic oil circulating through the pump impeller 120 and the turbine runner 150, the pressure regulator 210 changing a pressure applied to the hydraulic oil based on the plural states of the vehicle, the plural states including the starting state where the vehicle is starting and at least one of the stopped state where the vehicle is stopped and the cruising state where the vehicle is cruising.

According to the aforementioned embodiment, at least one of a fuel consumption and a power performance in the idling state of the torque converter is improvable.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A torque converter controller comprising:
a pressure regulator connected to a pipe that delivers a fluid circulating through a pump impeller and a turbine runner of a torque converter, the pressure regulator changing a pressure applied to the fluid based on a plurality of states of a vehicle where the torque converter controller is mounted, the plurality of states including a starting state where the vehicle is starting and at least one of a stopped state where the vehicle is stopped and a cruising state where the vehicle is cruising.

2. The torque converter controller according to claim 1, further comprising a controller detecting each of the plurality of states of the vehicle and controlling the pressure regulator based on the detected state of the vehicle.

3. The torque converter controller according to claim 2, wherein
the controller controls the pressure regulator in the starting state so that the pressure applied to the fluid is greater than the pressure applied to the fluid in the stopped state in a case where the plurality of states of the vehicle includes at least the starting state and the stopped state,
the controller controls the pressure regulator in the cruising state so that the pressure applied to the fluid is greater than the pressure applied to the fluid in the starting state in a case where the plurality of states of the vehicle includes at least the starting state and the cruising state.

4. The torque converter controller according to claim 3, wherein
the starting state includes a first starting state and a second starting state that occurs after the first starting state,
the controller controls the pressure regulator so that the pressure applied to the fluid in the second starting state is greater than the pressure applied to the fluid in the first starting state.

5. The torque converter controller according to claim 3, wherein
the controller acquires, as a threshold value, the number of rotations of an engine of the vehicle corresponding to a maximum torque of the engine obtained in the starting state of the vehicle,
the controller detects the cruising state when the number of rotations of the engine exceeds the threshold value.

6. The torque converter controller according to claim 4, wherein
the controller acquires, as a threshold value, the number of rotations of an engine of the vehicle corresponding to a maximum torque of the engine obtained in the starting state of the vehicle,
the controller detects the cruising state when the number of rotations of the engine exceeds the threshold value.

7. The torque converter controller according to claim 1, wherein the pressure regulator is a pressure regulating valve connected to the pipe and applying a pressure conforming to each of the plurality of states of the vehicle to the fluid that is delivered from the pipe.

8. The torque converter controller according to claim 2, wherein the pressure regulator is a pressure regulating valve connected to the pipe and applying a pressure conforming to each of the plurality of states of the vehicle to the fluid that is delivered from the pipe.

9. The torque converter controller according to claim 3, wherein the pressure regulator is a pressure regulating valve connected to the pipe and applying a pressure conforming to each of the plurality of states of the vehicle to the fluid that is delivered from the pipe.

10. The torque converter controller according to claim 4, wherein the pressure regulator is a pressure regulating valve connected to the pipe and applying a pressure conforming to each of the plurality of states of the vehicle to the fluid that is delivered from the pipe.

11. The torque converter controller according to claim 5, wherein the pressure regulator is a pressure regulating valve connected to the pipe and applying a pressure conforming to each of the plurality of states of the vehicle to the fluid that is delivered from the pipe.

12. The torque converter controller according to claim 6, wherein the pressure regulator is a pressure regulating valve connected to the pipe and applying a pressure conforming to each of the plurality of states of the vehicle to the fluid that is delivered from the pipe.

13. The torque converter controller according to claim 1, wherein
the plurality of states of the vehicle includes the cruising state and the starting state,
the pressure regulator is a temperature-sensitive bimetallic orifice connected to the pipe and including a first diameter in the starting state and a second diameter that is smaller than the first diameter in the cruising state so that a pressure applied to the fluid is greater than a pressure applied to the fluid in the starting state.
